(19) United States
(12) Patent Application Publication
(10) Pub. No.: US 2006/0044953 A1
(43) Pub. Date: Mar. 2, 2006

(54) Electronic device displaying printed information of optical storage media

(75) Inventor: Michael Chiang, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION, Taipei (TW)

(21) Appl. No.: 10/928,204

(22) Filed: Aug. 30, 2004

(51) Int. Cl. G11B 21/08

(52) U.S. Cl. 369/30.01

(57) ABSTRACT

An electronic device capable of displaying printed information of optical storage media includes a host and an optical access device. The optical access device has a upper cap which has a display zone. The host has a confirmation window corresponding to the display zone such that users can directly see and read the printed information of an optical storage medium held in the optical access device through the confirmation window and the display zone without removing the optical storage medium.

### FIELD OF THE INVENTION

The present invention relates to an electronic device and particularly to an electronic device capable of displaying printed information of optical storage media.

### BACKGROUND OF THE INVENTION

With the arrival of the digital age, electronic devices have played an important role in the work and life of many people.

For instance, many enterprises now use computer executable platforms to process data and store important data on optical storage media (called optical disks hereinafter) for backup that may be accessed through an optical access device (called optical disk drives hereinafter) for processing later. Students also can do homework through a computer executable platform and submit the homework through the optical disk. This has become a standard procedure in many schools. In addition, broadcasting digital audio or videodisks through a multimedia player (such as a DVD player) has become one of the important leisure activities of many people these days.

In short, reading and accessing optical disk data through the optical disk drive is one of the important methods for people to get information now. To confirm the content of an optical disk meeting one's requirement among many optical disks, the most commonly approach people take is to read the printed information on the optical disk. For instance, an audio CD that contains music usually has printed information regarding the name of the album, song sequence, song name, publisher's information, etc. to enable users to confirm whether the selected item is correct and the desired songs are included in the selected disk. On the other hand, many electronic devices (such as computer executable platforms) use optical disks to store special application programs (such as driving programs). Users have to read the printed information on the optical disks to confirm the required application programs before installation.

Many optical disk vendors, besides focusing the contents, also make a lot of efforts and use a lot of resources on the design of printing information of the optical disk aiming to attract user's attention and raise user's purchasing desire. Some even try to convey the enterprise's mission through a special printing design. Hence the printed information on the optical disk has become one of the important methods to convey information.

However, using the printed information on the optical disk as a medium to convey information is only effective when the optical disk in not yet loaded into the electronic device, because the upper cap of the present optical disk drives and the case of electronic devices mostly are made from opaque material. Once the optical disk is loaded into the optical disk drive, the content of the optical disk cannot be confirmed unless actually accessed and read.

This causes problems in use. For instance, some music CDs record the file names in the format of track 1, . . . , track n. Hence users cannot confirm the desired songs through the file names. Users have to confirm by removing the disk from the optical disk drive and reading the printed information. This is not convenient.

Moreover, many application programs have their serial numbers required during installation included in the printed information of the optical disk. The disk has to be removed to verify the serial number before to finish installation. This could cause reinstallation after the disk is reloaded into the optical disk drive.

All of the aforesaid problems create annoyance and need improvements, especially at present time, when customer-requirement-oriented-product-design is essential.

### SUMMARY OF THE INVENTION

In view of the aforesaid problems, the primary object of the invention is to provide an electronic device that is capable of displaying the printed information of an optical disk to enable users to read and check the optical disk in the optical disk drive any time.

In order to achieve the foregoing object, the electronic device according to the invention includes at least a host and an optical disk drive. The optical disk drive has an upper cap, which has a display zone for viewing the printed information of the optical disk. The host has a confirmation window corresponding to the display zone. Hence users can directly see and read the printed information of the optical disk through the display zone and the confirmation window when the optical disk is held in the optical disk drive.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A is a schematic view of an optical access device according to the invention.

FIG. 1B is a schematic view of an upper cap of the optical access device.

FIG. 1C is a schematic view of the optical access device containing an optical disk according to the invention.

FIG. 1D is a schematic view of a first embodiment of the invention after being assembled.

FIG. 2 is a perspective of a second embodiment of the invention.

FIG. 3 is a perspective of a third embodiment of the invention.

FIG. 4 is a perspective of a fourth embodiment of the invention.

### DESCRIPTION OF THE PREFERRED EMBODIMENTS

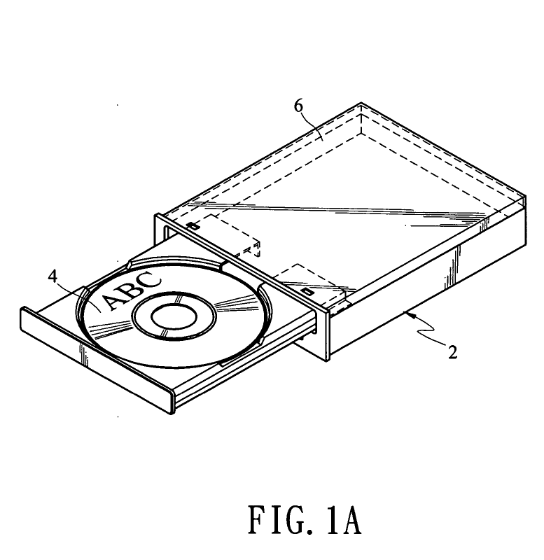

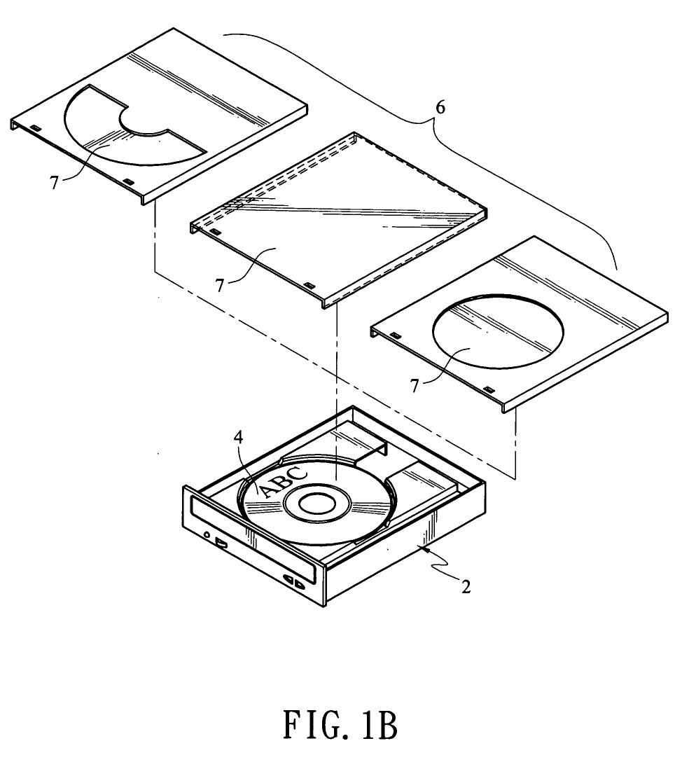

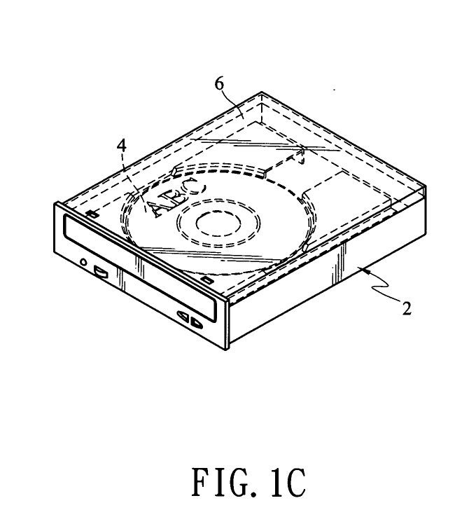

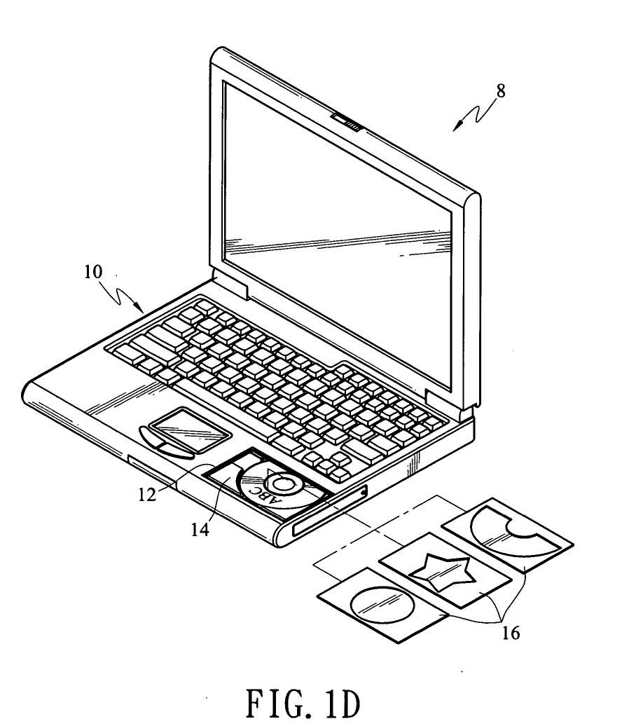

Refer to FIG. 1A for an optical disk drive 2 in an electronic device that can display printed information of an optical disk according to the invention. The optical disk drive 2 has an upper cap 6 and a loading mechanism (such as a tray). The upper cap 6 is located on one side of the optical disk drive opposite the loading mechanism to expose the location of the printed information of the optical disk. The tray holds the optical disk.

Referring to FIG. 1B, the upper cap 6 has a display zone 7 for viewing the printed information of the optical disk. The display zone 7 is made from a transparent or translucent material and formed in varying shapes and patterns. For instance, it may be a portion of the upper cap 6, such as at a size about one quarter of the optical disk or a semi-circle, or the like. Of course the entire upper cap 6 may serve as the display zone 7, then, the upper cap 6 has to be made from transparent or translucent material. If the display zone 7 covers only a portion of the upper cap 6, the display zone 7 may be latched on the upper cap 6 by coupling a plurality of locking pawls with anchor rings located on the upper cap 6.

The optical disk drive may be a read only optical disk drive (CD-ROM drive), a CD-Rewritable drive (CD-R/RW), a read only Digital Video Disc drive (DVD-ROM), a Digital VideoDisc-Rewritable Drive (DVD+R/RW), or a Combo drive, or the like.

Referring to FIG. 1C, when in use, an optical disk 4 is loaded into the optical disk drive 2 with the loading mechanism in a closed condition. Because the display zone 7 of the upper cap 6 is transparent or translucent, the printed information of the optical disk 4 may be read and verified.

Refer to FIG. 1D for a first embodiment of the invention. The optical disk drive 2 shown in FIG. 1B is located in a portable electronic device 8 which has a host 10 containing a confirmation window 12. The printed information of the optical disk held in the optical disk drive 14 may be seen and read through the confirmation window 12. The confirmation window 12 corresponds to the display zone (not shown in the drawing) of the upper cap of the optical disk drive 14.

In practice, a dust isolation plate 16 may be mounted onto the confirmation window 12. The dust isolation plate 16 may be latched on the confirmation window 12 by coupling a plurality of locking pawls with a plurality of anchor rings located on the confirmation window 12. The dust isolation plate 16 may be made from a transparent or translucent material and formed in varying shapes and patterns (such as a star, circle, crescent, and the like) for user selection and replacement as desired.

There is no specific rule for selecting the style and material of the dust isolation plate 16 and the display zone 7 of the optical disk drive 14. Any design and material are acceptable as long as users can see and read the printed information of the optical disk through the dust isolation plate 16, the confirmation window 12 and the display zone 7.

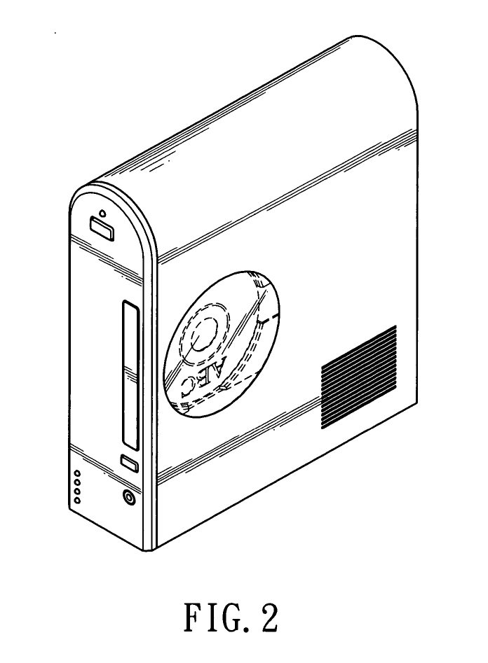

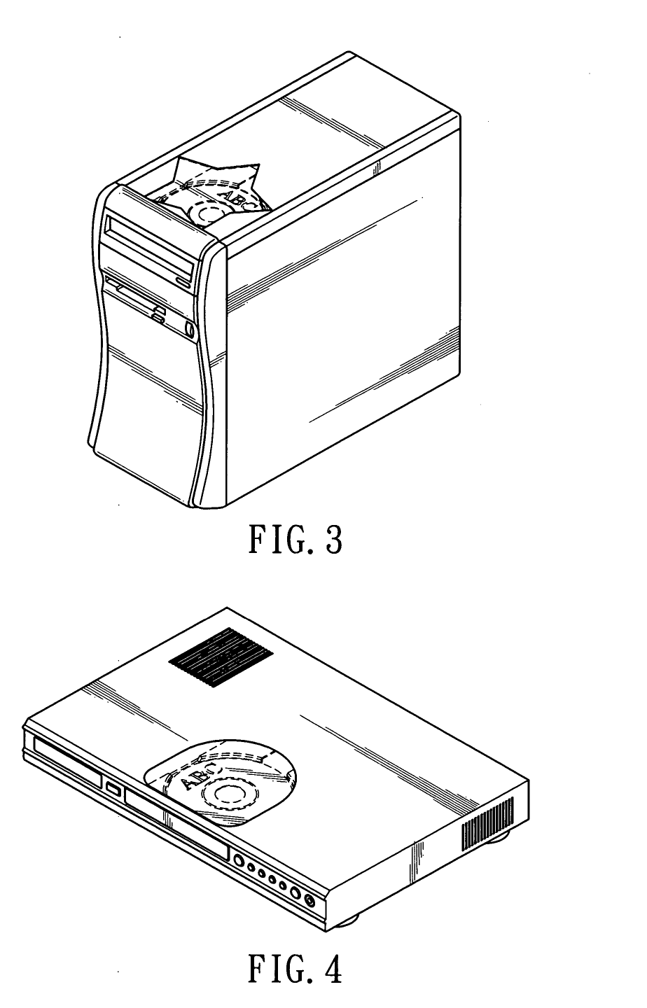

Refer to FIGS. 2, 3 and 4 for other embodiments of the invention adopted on different electric devices. FIG. 2 shows that the host is an information appliance (IA). In FIG. 3, the host is a desktop computer. In FIG. 4, the host is a VCD player a DVD player or a DVR player.

By means of the invention, users can directly see and read the printed information of the optical disk through the host. Hence users can get the required information readily without unloading the disk and reading the disk. It also can reduce damage of the electronic device, optical disk drive and optical disk. For instance, users who are not familiar with the electronic device and want to read the printed information of the optical disk held in the optical disk drive, could damage the optical disc drive, electronic device, and optical disk, due to an abnormal interruption: they try to retrieve the optical disk forcefully through the loading mechanism, while the electronic device is still operating.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

What is claimed is:

1. An electronic device displaying printed information of optical storage media, comprising a host and an optical access device located in the host for holding an optical storage medium, characterized by: the optical access device has a display zone, the host having a confirmation window corresponding to the display zone such that the printed information of the optical storage medium held in the optical access device are readable through the display zone and the confirmation window.

2. The electronic device of claim 1, wherein the display zone is located on a upper cap of the optical access device.

3. The electronic device of claim 1, wherein the display zone is made from a transparent material.

4. The electronic device of claim 1, wherein the display zone is made from a translucent material.

5. The electronic device of claim 1, wherein the confirmation window includes a dust isolation plate.

6. The electronic device of claim 5, wherein the printed information of the optical storage medium are readable through the dust isolation plate.

7. The electronic device of claim 5, wherein the dust isolation plate is made from a transparent material.

8. The electronic device of claim 5, wherein the dust isolation plate is made from a translucent material.
